(19) United States
(12) Patent Application Publication
(10) Pub. No.: US 2002/0096046 A1
(43) Pub. Date: Jul. 25, 2002

(54) Piston and method of producing the same

(76) Inventors: Christoph Drexler, Koblenz (DE); Gerd Roggenbuck, Neuwied (DE); Ulrich Seuser, Neuwied (DE); Markus Weber, Bremen (DE); Karl-Heinz Wollenweber, Ochtendung (DE)

Correspondence Address: MACMILLAN SOBANSKI & TODD, LLC, ONE MARITIME PLAZA FOURTH FLOOR, 720 WATER STREET, TOLEDO, OH, 43604-1619, US

(21) Appl. No.: 10/000,831

(22) Filed: Oct. 24, 2001

Related U.S. Application Data
(63) Continuation of application No. PCT/EP00/03422, filed on Apr. 14, 2000.

(30) Foreign Application Priority Data
Apr. 29, 1999 (DE) 19919574.9

(51) Int. Cl. F16J 1/04

(52) U.S. Cl. 92/208

(57) ABSTRACT

Methods are described, with which by expansion of metal foam it is possible in particular to manufacture pistons for brakes. This enables pistons of a very low wall thickness and high strength.

The invention relates to pistons, in particular for hydraulically operated brake systems. Specifically, the invention relates to so-called operating pistons for hydraulically operated disk brakes.

For decades and to an increasing extent in recent times the motor industry has been directing its efforts towards reducing the weight of a vehicle. These efforts are directed towards every component.

A conventional operating piston for a motor vehicle disk brake is usually made of steel, has a diameter of 54 mm and weighs approximately 370 g. An attempt to reduce the weight in a conventional manner by manufacturing the operating piston from plastic material or aluminium or extremely thin-walled deep-drawn sheet steel allows the weight to be reduced to around 185 g.

From EP 0 304 103 a typical piston made of deep-drawn sheet metal is known. There, in order with the thinnest possible sheet metal to achieve a high dimensional stability (rigidity) of the piston, the piston head is of a dome-shaped, concave or convex design. However, there too, a minimum sheet thickness of around 2.5 mm is required.

From EP 0 230 106 A2 an operating piston for a hydraulic brake is known, which comprises an inner rigid piston barrel encased by an elastic cover. For the piston barrel, metal or a rigid plastic material is proposed.

From the German patent specifications DE 40 18 360 C1 and DE 41 01 630 C2 methods of manufacturing porous metal bodies by expansion are generally known.

From WO 97/09222 steering knuckles of a composite structure are known, in which a cavity is packed with foam material. The sheet thickness of the shaped sheet-metal parts is in said case around 3 mm.

DE 30 40 125 A1 describes pistons for internal combustion engines, in which a separately manufactured piston head is connected to a piston skirt. A fibre-reinforced plastic material is used for strengthening purposes.

EP 0 304 103 A1 describes brake pistons, in which a dome-shaped head improves the stability of the piston.

DE 27 48 499 A1 also describes an, in terms of stability, improved brake piston with a special shaping of its head region.

DE 197 05 836 A1 describes a brake block, the lining carrier of which is of a sandwich-like construction comprising two sheet-metal plates with aluminium foam in between.

In the following publications the manufacture of foamed metals as such is described in detail:

J. BANHART, J. BAUMEISTER, M. WEBER: “Manufacture and Possible Applications of Components made of foamed Metals”, German publication, Car Manufacturing Materials 97/98, p. 34-37;

J. BANHART, J. BAUMEISTER, M. WEBER: “Metal Foam Now Fit For Industry”, German publication, The Design Engineer 10/94, p. 24-28;

J. BANHART, J. BAUMEISTER, M. WEBER: “Foamed Metals: Versatile and Now Easier to Manufacture”, German publication, Industrial Gazette 37/93, p. 48,49.

DE 41 39 020 A1 and DE 43 26 982 C1 describe special methods of manufacturing shaped parts from metal foam.

DE 195 09 018 A1 describes methods of manufacturing light and rigid composite parts, whereby a moulding body with a light metal foam is used.

DE 197 17 894 A1 describes a method of manufacturing porous metal bodies, in which special process parameters are observed.

DE 197 44 300 A1 describes methods of manufacturing porous shaped bodies from light metals, in which special heating means, namely induction coils, are provided.

Finally, DE 198 13 176 A1 describes a method of manufacturing composite material components, whereby powder foam is introduced into a molten metal.

The technical object of the invention is further to reduce the weight of a piston of the type described initially and yet maintain an adequate dimensional stability (rigidity).

Said object is achieved according to the invention in that the wall thickness of the piston skirt is less than or equal to 2 mm and the interior of the piston is at least partially packed with foam material.

Such a piston is preferentially used as an operating piston for a hydraulically operated brake, in particular a disk brake.

The invention makes it possible to reduce the thickness of the piston skirt, made in particular of sheet steel, even further without the dimensional stability (rigidity) of the piston falling below the permitted level. According to preferred refinements of the invention, the wall thickness of the piston given the use of sheet steel is less than or equal to 1.5 mm, in particular less than or equal to 1.0 mm; further, in particular less than or equal to 0.8 mm. The sheet steel used for the piston skirt may in a known manner be shaped by deep-drawing, rolling etc.

A metal foam, in particular an aluminium foam, is preferentially used as a foam. To said extent, reference is made to the prior art cited above (in particular DE 40 18 360 C1 and DE 41 01 630 C2).

According to a variant of the inventive idea, the piston may substantially be manufactured also without a piston skirt; it then substantially comprises a foam body, in particular of metal foam.

Another variant of the inventive idea provides that the piston skirt is made of a duromer and the interior of the piston at least partially comprises a foam body. Duromers (also known as thermosetting plastics) are defined in DIN (German industrial standard) 77 24.

A particularly preferred refinement of all described variants of the invention provides that the foam material has a greater density in the outer region of the piston, i.e. at or close to the piston wall, than in the inner region of the piston. Thus, while achieving a further weight reduction a high dimensional stability (rigidity) of the piston is maintained.

Said purpose is also served by a further preferred refinement of the invention, according to which the gas bubbles in the foam do not have a random shape or alignment but have a greater diameter in one direction than in a direction perpendicular thereto, i.e. are e.g. ellipsoidal in shape. In said case, the asymmetric gas bubbles are aligned in such a way that their longer axes are parallel to the main direction in which the loading force acts. When different forces act from different directions upon different points of the piston, the longitudinal directions of the anisotropically aligned gas bubbles are adapted in each case to the main direction in which the force acts, i.e. they extend in each case substantially parallel to said main direction in which the force acts.

A further increase of dimensional stability (rigidity) may be achieved by designing the piston head in a concave manner.

A method according to the invention of manufacturing a piston having a piston skirt and a piston head provides that during the deep-drawing operation an expandable body is moulded with the piston head and/or the piston skirt. It is therefore possible for the expandable body during or after further deep-drawing steps to be expanded in an accurately fitting and homogeneous manner in the piston.

To prevent an oxide film between the expandable body and the piston head from impeding their intimate connection, according to a preferred refinement of the invention it is provided that the expandable body (the “pill”, see below) is impressed with high friction, i.e. in the sense of a so-called “friction welding operation”. If an oxide film is present, it is therefore rubbed away. Pressure welding may also be advantageous for achieving the said intimate connection between the expandable body and preferentially the piston head and optionally additionally also the piston skirt.

The foam materials according to the invention, i.e. in particular the previously described expandable body, preferentially comprise metal powder, in particular aluminium powder, having propellent, in particular titanium hydride powder, distributed therein.

According to a preferred refinement of the previously described method, it is provided that the expandable body is expanded under the effect of heat and shaping while simultaneously being adapted and bonded to piston skirt and piston head. Thus, during the expansion process an adequate bonding with the piston skirt is effected as a result of the effect of heat and the pressures arising during the expansion process. In said case, what is above all advantageous for the stable bond is that at the point of contact with the piston skirt and piston head the atmospheric oxygen is extensively displaced.

The sought-after intimate connection between the metal foam body and the piston wall, in particular the piston head, already addressed above may also be achieved in that, given the use of a piston skirt made of steel, the latter during manufacture is overheated relative to the aluminium foam body. Admittedly, aluminium as it cools has a stronger contraction effect but the effect of overheating of the steel skirt (i.e. the steel skirt being heated to a greater extent than the aluminium foam body) is that during cooling the steel skirt contracts to a greater extent and so the intimate connection to the metal foam body is achieved.

A particularly preferred refinement of the invention provides the use of stainless steel (special steel). Up until now, the use of special steel in brake construction has been avoided for reasons of cost. However, because of the low wall thickness which is possible according to the invention, said cost drawback is offset and the use of stainless steel made possible. For example, special steel according to DIN (German industrial standard) 1.43.03 was used. Special steel of the type X 12 CrNiMoTi 18.10 has also proved successful.

A variant of the method according to the invention of manufacturing a piston having a piston skirt and piston head, wherein the method comprises a pressing and/or deep-drawing and/or milling and/or rolling operation, provides that for manufacture a metal sheet or a duromer plate is used, which is at least partially coated with an expandable material, which is expanded during or after shaping of the piston. By said means, not only is manufacture simplified but it may also be ensured that a maximum possible bond is produced between expanded material and piston skirt and/or piston head.

A particularly preferred refinement of the previously described method according to the invention provides that the foaming process is effected in a dimension-stabilizing mould. A precise shape of the piston is thereby ensured.

A further variant of the method according to the invention of manufacturing a piston provides that a prefabricated foam body is inserted into a likewise prefabricated piston skirt and fastened there. The foam body is preferentially formed from the previously described materials.

In said case, the prefabricated foam body may be fastened preferentially by means of a press fit, adhesive or foam, in particular metal foam or plastic foam, in the piston skirt and/or to the piston head. It is also possible to use for manufacture of the piston a piston skirt, which is coated with an expandable material. A prefabricated foam body may then be inserted into the cavity of the piston and, during heating, said coating expands and by virtue of said expansion the inserted foam body is connected in a highly intimate manner to the piston wall.

A further preferred variant of the invention provides that the average gas cell size of the foam is smaller in outer regions of the piston than in inner regions. This applies to all of the previously described apparatus- and method-related aspects of the invention. By the “gas cell size” of the foam, the volume of the gas cells forming the foam is meant.

Rotating the skirt about its axis of symmetry during forming of the foam and/or during expansion may be used to achieve the effect whereby, as a result of the centrifugal forces, there is a higher metal density and also a lower pore size in outer regions of the developing foam body, i.e. in particular at the outer surface. Depending on the rotational speed, the effect may be achieved whereby the outer skin of the foam body becomes sufficiently hydraulically sealed to allow the foam body thus formed to then be used without a separate piston skirt made of different material.

A further variant of the method according to the invention of manufacturing a piston provides that a prefabricated foam body is cast round with diecasting material. The low weight of materials including manufacturing losses, also known as shot weight, particularly given the use of aluminium and magnesium, plus the short clock cycle time and the low thermal conductivity of the foam core enable the use of said technique. In said case, a good bond between diecast skirt and foam may be achieved by metal blending and/or by shrinking-on as the molten material solidifies with positive locking in the, here, at least partially open pores of the foam body. A temperature-conditioned partial melting onto the outer skin of-the metal foam may also be provided.

A further variant of the invention provides a method of manufacturing a body from metal foam, whereby a mixture of metal powder, in particular aluminium powder, with a propellent, in particular titanium hydride powder, is sprayed under the effect of electric and/or magnetic fields onto a backing or into a mould. Said method is usable generally, not just to manufacture pistons of the type presently under discussion. Rather it may be used to manufacture any desired foam bodies and foam body reinforcements in hollow bodies. The movement of the particles may be controlled by the electric and/or magnetic fields. Said method is preferentially effected in the manner of a modified centrifugal casting method, whereby the residual heat of the molten material is utilized to carry out the expansion in the aluminium/titanium hydride mixture. In said case, a homogeneous mixture of aluminium powder and titanium hydride powder is injected into a cavity (hollow space). Expansion of the propellent leads immediately to the formation of bubbles which, when they encounter already deposited material, combine to form a closed foam structure. When the method is implemented using the centrifugal casting technique, the newly formed foam structure presses itself into the existing centrifugally cast material and a strong bond is produced both by metal bonding and by positive engagement.

In a further refinement of said method it is provided that the mixture of aluminium powder and titanium hydride powder is already foamed in the injection nozzle and that the foam is then introduced into the cavity.

There now follows a detailed description of embodiments of the invention with reference to the drawings.

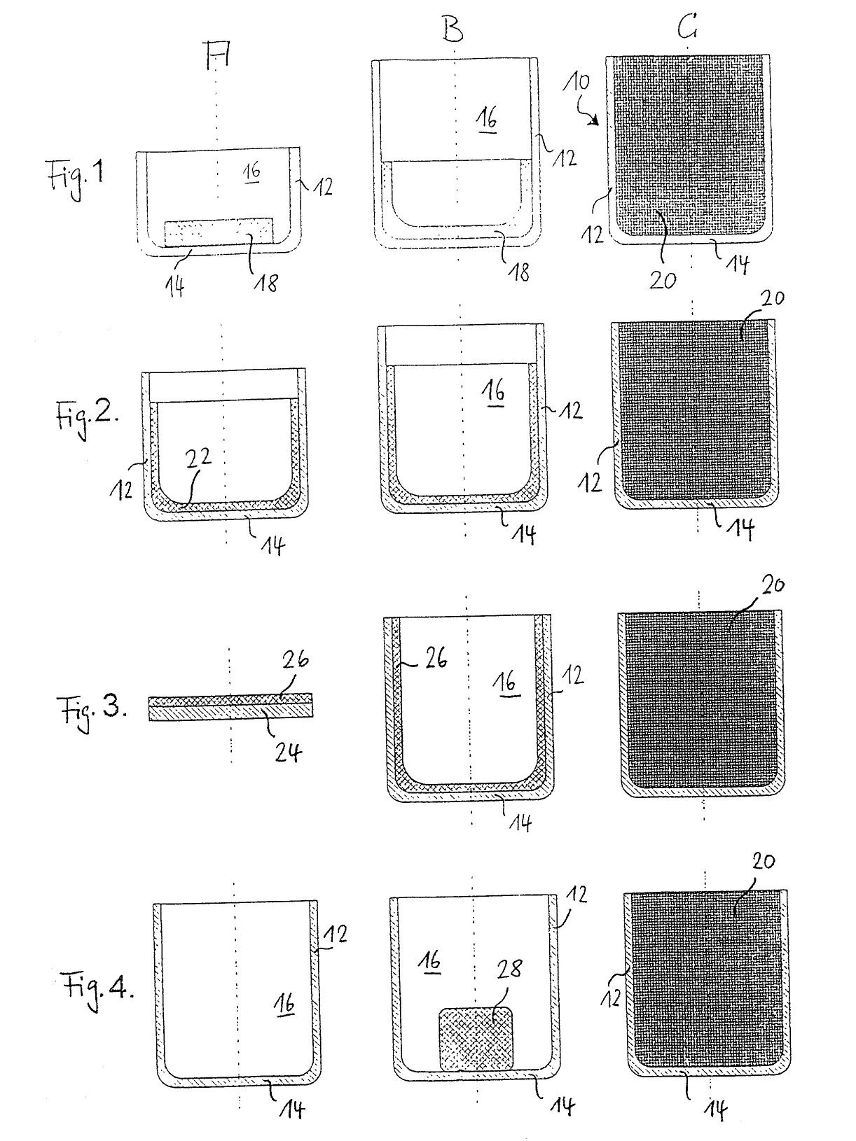

FIGS. 1 to 15 each show various embodiments of pistons and/or of the manufacture of such pistons.

In FIGS. 1 to 9, in each case three characteristic process steps are diagrammatically illustrated alongside one another and differentiated by the letters A, B and C (the letters A, B and C are indicated only above FIG. 1 but apply equally to the successive FIGS. 2 to 9).

FIGS. 1A, 1B and 1C diagrammatically illustrate three presently relevant stages of a piston-forming operation, in particular by deep-drawing. The finished piston 10 is shown in FIG. 1C. The piston wall 12 in the finished state is approximately 0.7 mm thick.

FIG. 1A shows a state during manufacture of the piston by deep-drawing. The piston still does not have its final height and accordingly the wall thickness of the piston wall 12 is still greater than in the finished state (FIG. 1C). In the deep-drawn state according to FIG. 1A, an expandable body 18 is inserted into the interior 16 of the piston. The expandable body 18 is made of aluminium powder with homogeneously distributed metal hydride powder, e.g. titanium hydride powder. For example, 0.4% by weight of titanium hydride powder may be put in the powder mixture. The titanium hydride is the propellent. The expandable body 18 may also be referred to as a “tablet”. Its manufacture as such may be inferred from the previously cited prior art.

FIG. 1B shows a state after further deep-drawing, wherein the expandable body 18 is pressed with an accurate fit into the developing piston. A non-slip connection arises as a result of the pressing and/or metal bonding with piston wall 12 and piston head 14. Then, at least the expandable body 18 is heated beyond its melting point, e.g. by means of an oven or by inductive heating, and the metal hydride decomposes and forms bubbles in the aluminium. Once the aluminium has expanded, the finished piston with the expanded aluminium body 20 is formed, which is shown in FIG. 1C.

FIG. 2 shows a modification of the previous embodiment. In all of the drawings, components which are identical or have a similar function to one another are provided with identical reference characters. In the embodiment according to FIG. 2, between various deep-drawing steps a small pot 22 made of a compressed powder mixture of aluminium and titanium hydride is pressed with an accurate fit into the semifinished piston skirt 12. FIG. 2B shows the state after deep-drawing and/or pressing and/or milling and/or rolling, i.e. the piston skirt 12 has attained its final shape and thickness, as has the piston head 14. The pot 20 of expandable material is then expanded in the manner described above.

FIG. 3 shows, as the starting material of piston manufacture, a metal sheet 24 which is coated with a layer 26 of expandable material. Preferably, here too, sheet steel may be used and the layer 26 of expandable material may comprise the previously described moulded powder compound of aluminium and titanium hydride. When coating the sheet steel 24 with the layer 26, care is taken to ensure that a metal bond is produced over the entire boundary surface in order to prevent the formation of an oxide film which would later lead to a separation between foam and piston wall. The starting material according to FIG. 3A is then in an, as such, known manner brought by deep-drawing and other forming techniques into the shape according to FIG. 3B and then an expansion in the previously described manner is effected so as to produce a piston according to FIG. 3C with expanded body 20.

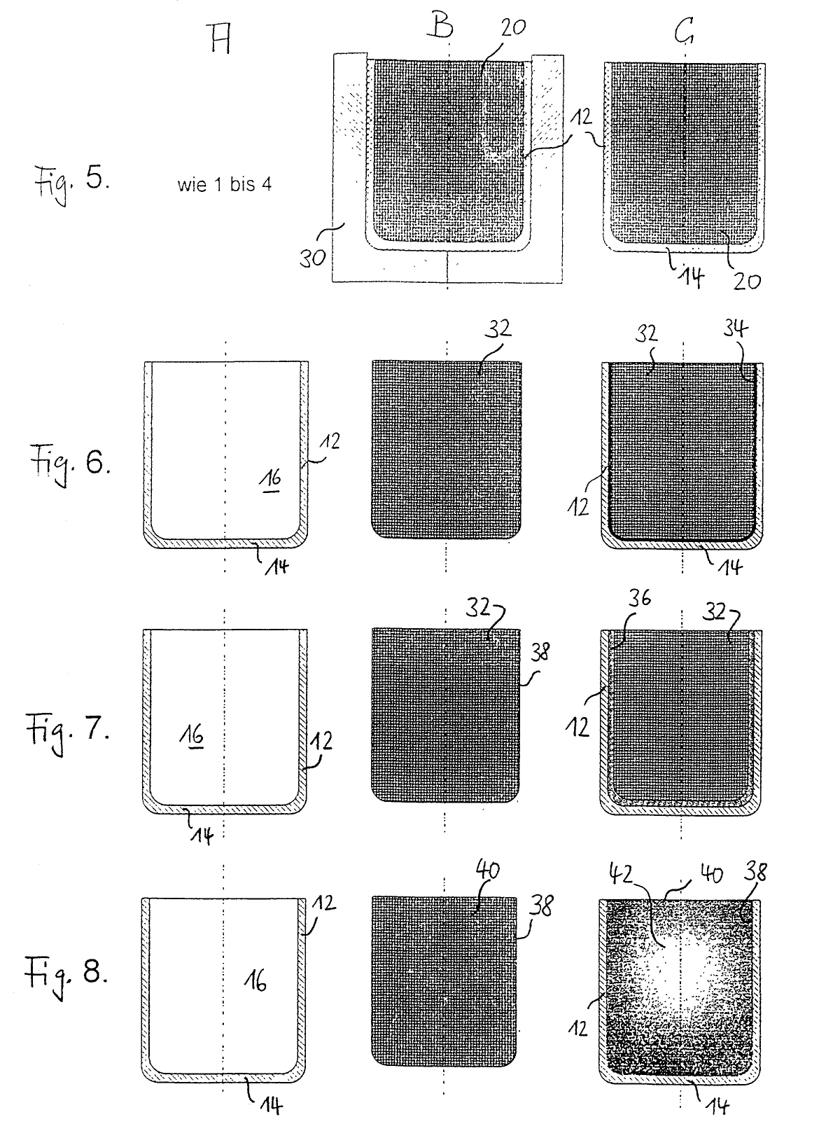

FIG. 4 shows a simplified modification of the previously described embodiments. Here, the piston is first completely formed (e.g. by deep-drawing etc.) so as to produce the final shape of the piston wall 12 and the piston head 14 shown in FIG. 4A. An expandable tablet 28 is inserted into said shape without any metal bonding with the sheet steel of piston head 14 and piston wall 12 arising. The tablet 28 is directly expanded so as to form the finished piston according to FIG. 4C.

In the embodiments according to FIGS. 1 to 4, any surplus foam material projecting above the top edge of the piston skirt 12 may be mechanically removed to ensure a flush termination of piston wall and foam body 20.

In the embodiment according to FIG. 5, aluminium is used as the starting material for the piston wall 12 and the piston head 14. The first steps may be effected as in FIGS. 1 to 4, i.e. FIG. 5A corresponds to any one of FIGS. 1A, 2A, 3A or 4A. The difference lies in the foaming process on account of the close proximity of the melting temperature of aluminium and the foaming temperature of the powder mixture of aluminium and titanium hydride. For said reason the foaming process is carried out in a dimension-stabilizing mould 30, thereby preventing warping or even a break-out of the expanding foam through the piston wall 12 or the piston head. FIG. 5C then shows the finished piston. An extremely strong metal bond of the expanded body 20 with the piston wall 12 and piston head 14 made of aluminium is produced.

FIG. 6 shows a further embodiment, in which piston skirt and piston head are brought by known shaping methods into their final shape, i.e. prefabricated, and a foam body 32 is also prefabricated. The piston skirt and piston head may be manufactured e.g. from aluminium or sheet steel. The outer skin of the prefabricated foam body 32 may have an open pore structure. The prefabricated foam body 32 is then glued by means of plastic material 34 in the piston skirt 12 and piston head 14.

FIG. 7 shows a further embodiment, which substantially corresponds to the embodiment according to FIG. 6 but is modified in that the fastening of the prefabricated body 32 in the piston is effected in such a way that the open-pored outer skin of the foam body 32 is glued by means of a special foam layer 36 in the piston. The material of the foam layer 36 may correspond to, or differ from, the material of the foam body 32 but is separately expanded so as to produce the strong bonding of the foam body 32 in the piston.

FIG. 8 shows a modification of the embodiment according to FIG. 7 in that the foam cell size in the piston is not homogeneous. A prefabricated foam body 40 is again used, which has a relatively large foam cell size, i.e. the individual foam bubbles have a relatively large volume. This may be controlled by the mixing ratio and further foaming parameters. When in the embodiment according to FIG. 7 the outer foam layer 36 is mixed differently, namely so as to produce smaller foam cell sizes, on the whole a piston is formed, in which the foam cell size is greater in the inner region than in the outer region.

This may also be achieved in a different manner in the embodiment according to FIG. 8, e.g. by means of an inhomogeneous mixture of the starting tablet and/or inhomogeneous control of the heating of the expandable material during expansion, e.g. through purposeful irradiation by heat-generating electromagnetic radiation. The end result in the piston is a foam body 40, which has larger bubbles in its inner region 42 than in the region of its outer wall.

FIG. 9 shows a further embodiment, in which a prefabricated foam body with a closed surface 46 is pressed into a prefabricated piston skirt 12 with piston head 14.

In the previous embodiments according to FIGS. 6 to 9, the prefabricated foam body may be sealed in a particular manner at its surface. When the foam body is formed from metal foam, it is possible, for example, to immerse it in a liquid metal such as bismuth, thereby achieving good glazing and sealing of the porous surface.

A foam body made of plastic foam may also be glazed and sealed in said manner through immersion in (or wetting with) a liquid plastic material.

It is also possible to seal a metal foam body with plastic material. Thus, for example, an aluminium-based metal foam body may be immersed in plastic material or wetted with plastic material, wherein the plastic material glazes and seals the surface. The mechanical support effect of the foam body is however still guaranteed by the metal structure alone.

The following embodiments preferentially provide as a material for the piston wall, not sheet steel, but other materials.

In the embodiment according to FIG. 10, a prefabricated foam body 44 is pressed with an accurate fit into a skirt 48 made of a duromer. The duromer skirt then forms the outer skin of the piston.

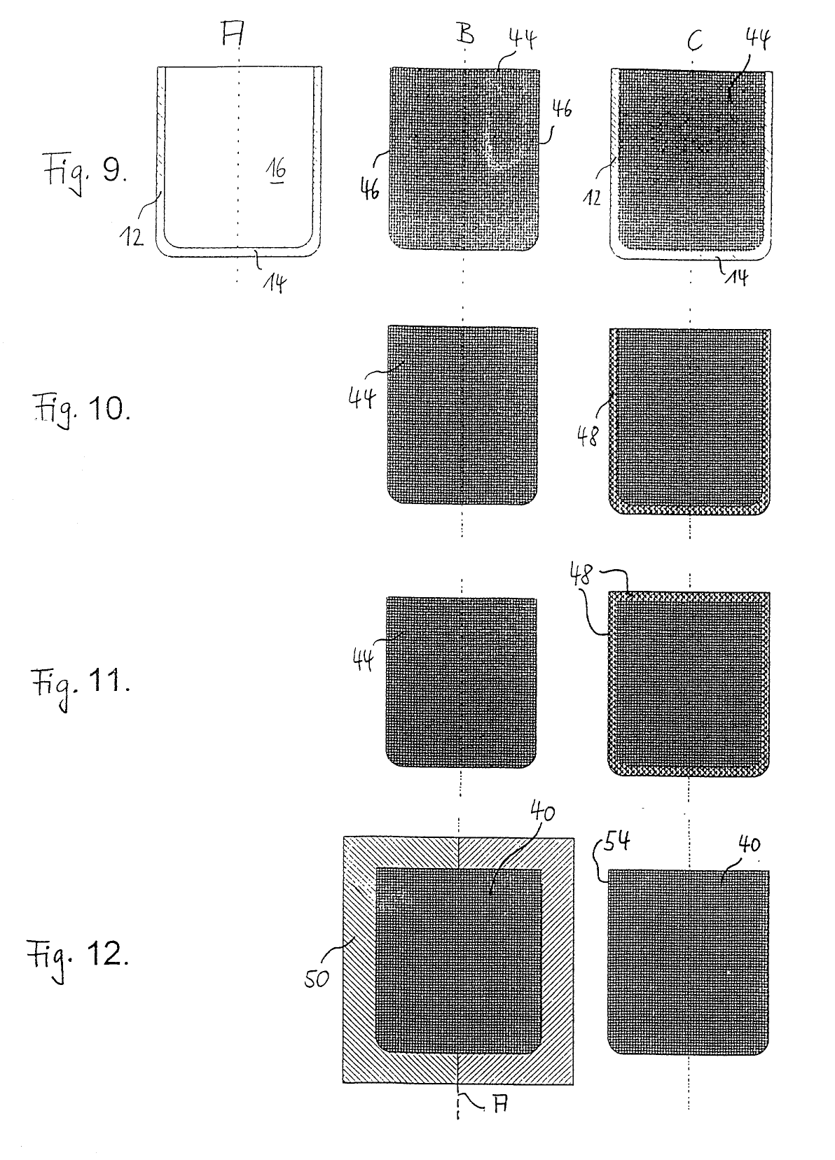

FIG. 11 shows a further refinement of said variant, in which duromer has been injection-moulded around the entire foam body 44.

In the embodiment according to FIG. 12, the metal foam 40 is foamed in such a way that its outer skin directly has a hydraulically sealed and adequately strong structure. This is promoted by the fact that the foam during foaming is rotated (centrifuged) about a centre line A. For said purpose the mould 50, in which the expansion process is effected, is rotated about the axis A. By said means, a high metal density in the outer region, in particular a closed-pore outer skin 54 is achieved.

FIG. 12C therefore shows a finished, serviceable piston made from a foam body 40.

FIG. 13 shows details of the mould 50 comprising two halves 50, 50′ and having pivot bearings 52, 52′ for rotating the mould about the longitudinal axis A.

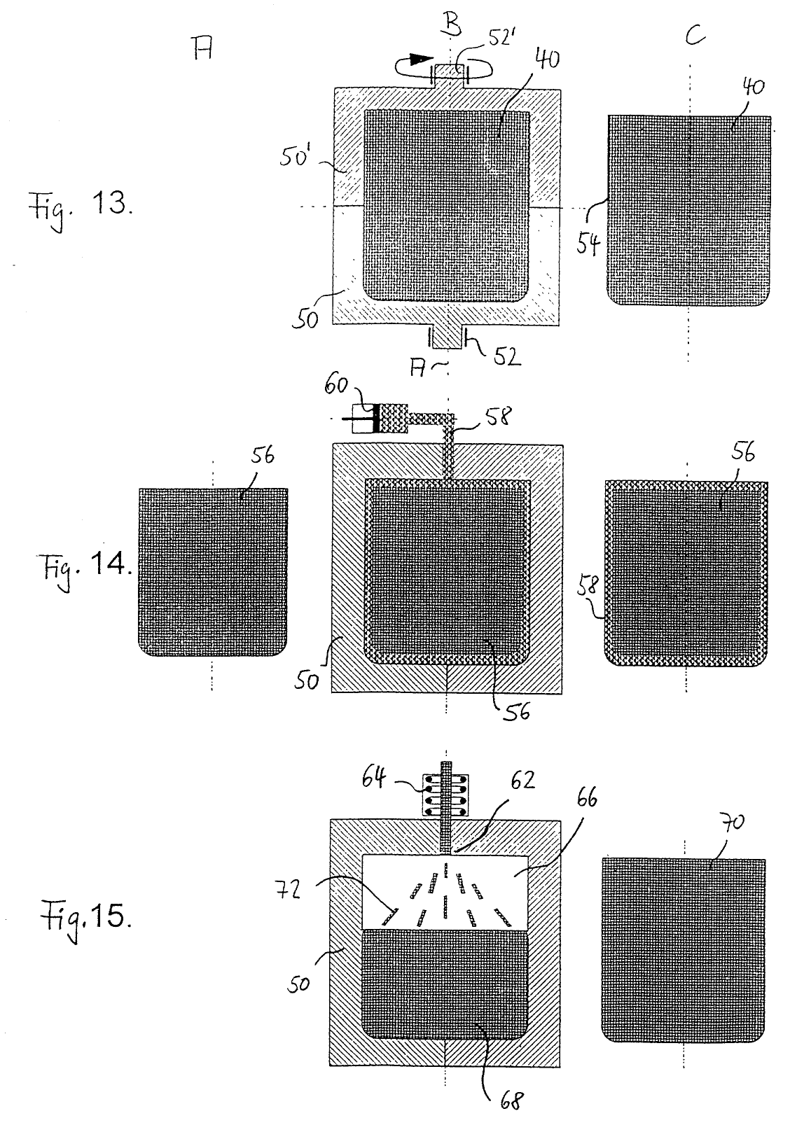

FIG. 14 shows a further embodiment, in which diecasting material 58 is cast around a prefabricated foam body 56 in a mould. By means of a plunger 60 the diecasting material is pressed at the required temperature into a gap between the prefabricated foam body 56 and the inner wall of the mould 50. The low weight of materials including manufacturing losses (especially given the use of aluminium or magnesium) and the short clock cycle time as well as the low thermal conduction of the foam core enable the use of the diecasting technique. FIG. 14C shows the finished piston with foam core 56 and diecast skirt 58.

FIG. 15 shows a mould 50, into which a homogeneous powder mixture of aluminium and titanium hydride (so-called aluminium/titanium hydride matrix) is injected through a nozzle 62, i.e. into a cavity 66 inside the mould 50. During said process the mould is rotated. Immediately upon contact, bubbles are formed and bond with the already formed foam structure 68. Said foam structure presses itself into the centrifugally cast material.

In a further embodiment, first the piston skirt is manufactured in a centrifugal casting process. Then, in accordance with FIG. 15 the mixture of aluminium-and titanium hydride is injected. The residual heat of the skirt and the mould is utilized to foam the mixture.

The following general remarks should be made about the powder mixture presently under discussion. Aluminium powder and metal hydride powder, as a loose powder mixture, do not enable expansion because the propellent being released from said mixture of the two powders could immediately escape. For said reason, the two powders are compressed and compacted. The powder pressed together in said manner produces a solid body. Said bodies are also known as “tablets”. Such tablets may then be finely ground. What is then formed is once more a powder-like mixture. However, said powder is not to be confused with the powder mentioned at the beginning of this paragraph because in terms of expandability it has totally different properties. For, with the comminution of the tablet as a result of grinding, enough metal hydride particles remain enclosed by the aluminium particles so that, when heat is supplied, the expansion of the propellent expands the aluminium particles and the propellent therefore does not simply deflagrate. The tablets should therefore not be crushed too finely in order to prevent deflagration of the propellent. It is in said sense that the term “powder mixture” is meant here. The same applies to compacted states of aluminium powder and metal hydride powder, which are to be covered by said term.

The method according to FIG. 15 may be modified such that heating is already effected in the region of the nozzle 62 so that foam formation-starts already in the nozzle. In said case, the powder mixture is introduced preferentially in a not yet fully expanded state into the piston, where it then fully expands and attains its final shape.

FIG. 15 further shows a special feature in the form of deflecting coils 64 in the region of the nozzle 62-, which generate an electromagnetic field as far as into the cavity 66 and hence enable control of the movement of the injected particles, including the formed foam. Said method is generally usable for producing bodies or body fillings of metal foam. It may be used in any situation where the electric/magnetic properties of the injected particles 72 effect a deflection in the electric/magnetic field. In FIG. 15 the coil 64 is only diagrammatically indicated. It is important that the electric and/or magnetic fields act in the desired manner upon the particles 72 flying freely through the cavity, i.e. influence the movement of the particles. In said manner, complex foam structures may be created. Through purposeful local irradiation with heat-generating radiation (e.g. infrared radiation) of the still flying and optionally already at least partially expanding particles it is also possible to control the foam formation, i.e. in particular the size, distribution and orientation of the bubbles.

It has also emerged that by means of electromagnetic fields bubbles (pores) may be aligned (oriented) in the metal foam body, namely by moving the electromagnetic fields during production of the foam body. When in the process shown in FIG. 15 the electromagnetic field generated by a coil 64 is moved axially upwards, the gas bubbles in the developing foam body are likewise aligned axially, i.e. they have an elongate shape, e.g. an egg shape, wherein the longer axis of the bubble aligns itself increasingly axially, i.e. perpendicular to the piston head. This is desirable in terms of improving the stability in the critical direction. By rotation about the longitudinal axis the bubbles in the radial edge region, i.e. close to the piston skirt, may be radially aligned in a desired manner, i.e. the longer axis of the asymmetric gas bubbles is then perpendicular to the piston skirt, which likewise improves the stability of the piston with regard to the dominant forces.

The said electromagnetic fields are also used to heat the material (capacitance current heating).

Tests show that all of the previously described pistons combine a very low weight with high compressive strength. Given a wall thickness of the embodiments according to FIGS. 1 to 4 of 0.5 mm and a foam density of 0.7 g/cm³, damage arose only at a pressure of 200 bar. Given a wall thickness of 0.725 mm and a concave piston head as well as a foam density of 0.8 g/cm³, damage arose only at a pressure of 310 bar. The same pistons attain the fatigue limit, customary in brake construction, of 250,000 stress cycles with pressure loads of, in each case, between 0 and 100 bar and at temperatures between −40° C. and +120° C. Further tests produced positive results for 275,000 stress cycles at 0 to 140 bar and temperatures of +20° C. to +400° C. Equally positive results were obtained from a dynamic fatigue test with a braking torque corresponding to a vehicle deceleration of 10 m/sec², as well as from an ABS simulation test and a vibration test.

The brake operating pistons manufactured according to the invention weigh in the region of 110 g.

Also advantageous are the reduced thermal conductivity and the noise-damping properties of the pistons manufactured according to the invention.

It is possible to dispense with expensive chromium plating, which in particular results in less environmental pollution. Where the pistons according to the invention have an aluminium skin, they may in a known manner be anodized.

1. Piston (10), in particular for a hydraulically operated brake, having a piston skirt (12), a piston head (14) and an interior (16) delimited by them, characterized in that the wall thickness of the piston skirt (12) is less than or equal to 2 mm and that the interior (16) is at least partially packed with foam material.

2. Piston according to claim 1, characterized in that the wall thickness is less than or equal to 1.5 mm; in particular less than or equal to 1.0 mm; further in particular less than or equal to 0.8 mm.

3. Piston according to one of claims 1 or 2, characterized in that the piston skirt (12) is made of steel sheet.

4. Piston according to one of the preceding claims, characterized in that the foam is a metal foam, in particular an aluminium foam.

5. Piston, in particular for a hydraulically operated brake, substantially comprising a foam body (40), in particular of metal foam, wherein the foam body (40) also forms the piston skirt.

6. Piston, in particular for a hydraulically operated brake, having a piston skirt, a piston head and an interior delimited by them, characterized in that the piston skirt (48) and the piston head (12) are made integrally from a duromer and the interior at least partially from a foam body (44).

7. Piston according to claim 6, characterized in that duromer is injection-molded around the foam body (44).

8. Piston according to one of the preceding claims, characterized in that the foam material at least partially has a greater density in its outer region than in its inner region.

9. Piston according to one of the preceding claims, characterized in that at least some gas bubbles in the foam have an ellipsoidal shape and are aligned anisotropically.

10. Piston according to one of the preceding claims, characterized in that the piston head is concave.

11. Method of manufacturing a piston, in particular for a hydraulically operated brake, having a piston skirt (12), a piston head (14) and an interior (16) delimited by them, wherein the method comprises a deep-drawing operation, characterized in that during the deep-drawing operation an expandable body (18) is molded with the piston head (14) and/or the piston skirt (12), in particular by high friction welding or pressure welding.

12. Method according to claim 11, characterized in that the expandable body (18) comprises metal powder, in particular aluminium powder, with propellant, an particular metal hydride powder, distributed therein, wherein in particular titanium, zircon or magnesium is provided as a metal.

13. Method according to one of claims 11 or 12, characterized in that the expandable body (18) is expanded under the effect of heat and shaping while simultaneously being adapted and bonded to piston skirt and piston head.

14. Method of manufacturing a piston, in particular for a hydraulically operated brake, having a piston skirt (12), a piston head (14) and an interior (16) delimited by them, wherein the method comprises a pressing and/or deep-drawing and/or milling and/or rolling operation, characterized in that for manufacture a metal sheet is used which is at least partially coated with an expandable material which is expanded during or after shaping of the piston.

15. Method of manufacturing a piston, in particular for a hydraulically operated brake, having a piston skirt, a piston head and an interior delimited by them, wherein the method comprises a plastic molding method, in particular injection-molding, characterized in that a plastic semifinished product is used which is at least partially coated with an expandable material which is expanded during or after shaping of the piston.

16. Method according to one of claims 11 to 15, characterized in that the expansion process is effected in a dimension-stabilizing mold (30).

17. Method of manufacturing a piston, in particular according to one of claims 1 to 10, characterized in that a prefabricated foam body (32, 44) is inserted into the piston skirt (12, 48) and fastened there.

18. Method of manufacturing a piston, in particular according to one of claims 1 to 10, characterized in that expandable material is introduced in a partially expanded state into the piston skirt (12, 48), where it is completely expanded.

19. Method according to claim 17, characterized in that the prefabricated foam body (32) is fastened by means of an adhesive (34) or a foam (36), in particular metal foam or plastic foam.

20. Method according to one of claims 11 to 19, characterized in that the gas cell size of the foam is smaller in outer regions of the piston than in inner regions.

21. Method of manufacturing a piston, in particular for a hydraulically operated brake, from an expanded material, characterized in that the foam is rotated during expansion.

22. Method of manufacturing a piston, in particular for a hydraulically operated brake, characterized in that a prefabricated foam body (56) is cast round with diecasting material (58).

23. Method of manufacturing a body from metal foam, characterized in that a mixture of metal powder, especially aluminium powder, and a propellant, especially metal hydride powder, is compacted and the powder thus compacted is comminuted such that an expansion of the power gas generates a foaming up following the supply of heat and that under the effect of electric and/or magnetic fields the comminuted mixture of metal powder and propellant is applied, in particular layer by layer, onto a backing or into a mold (50).

24. Method according to claim 23, characterized in that the powder mixture is introduced into a hollow mold (50).

25. Method according to claim 24, characterized in that the hollow mould (50) rotates during introduction of the powder mixture.

26. Method of manufacturing a piston, in particular for a hydraulically operated brake, having a piston skirt, a piston head and an interior delimited by them, characterized in that the interior is at least partially packed with foam material and that the residual heat of a preceding production stage, such as e.g. centrifugal casting, is used to expand material introduced into the interior.

27. Method according to one of claims 11 to 26, characterized in that the expansion under the effect of heat is effected by means of electromagnetic radiation, in particular by means of infrared radiation.

28. Method according to one of claims 11 to 26, characterized in that the expansion under the effect of heat is effected by means of electromagnetic fields, in particular by means of induction heating.

29. Method according to claim 27 or 28, characterized in that the irradiation of electromagnetic energy is controlled so as to produce at least partially ellipsoidally shaped bubbles in the foam.

30. Method according to claim 29, characterized in that the longitudinal axis of the ellipsoid is oriented in such a way that it extends at least approximately in the direction of the main force acting upon the piston.

31. Method according to claim 30, characterized in that the longitudinal axes of the ellipsoids extend axially in the region of the piston head and radially in the region of the piston skirt.
